(19) United States
(12) Patent Application Publication
(10) Pub. No.: US 2015/0053062 A1
(43) Pub. Date: Feb. 26, 2015

(54) Interchangeable Mouthpieces for Brass Instruments

(71) Applicant: Gary Hebert, Pasadena, TX (US)

(72) Inventor: Gary Hebert, Pasadena, TX (US)

(21) Appl. No.: 13/974,630

(22) Filed: Aug. 23, 2013

(51) Int. Cl. G10D 9/02

(52) U.S. Cl. CPC G10D 9/026
USPC 84/398

(57) ABSTRACT

Musicians skilled in the specialization of brasswind instruments often desire to work out the facial muscles in preparation for a wide range of tonal registries. Most mouthpieces for particular brasswind instruments come in a very small variation of diameters and cup depths. This limitation creates problems when looking to improve higher tone or lower tone ranges. Presently, the musician must try to modify a mouthpiece from an entirely different instrument to satisfy this need. This invention focuses on keeping the shank standardized to couple with the matching instrument while allowing the user to change the cup portion of the mouthpiece to differing sizes and depths. This design enables the user to work a much wider range of tonal registers with the simplicity of a threaded connection between the shank and the cup.

### CROSS-REFERENCE TO RELATED APPLICATIONS

This application is claiming benefit from the previously filed provisional patent application with the application Ser. No. 61/679,749 with a filing date of Aug. 24, 2012

### FIELD OF THE INVENTION

The present invention generally relates to an interchangeable mouthpiece for use with brass instruments.

### BACKGROUND OF THE INVENTION

Brass Musicians often spend countless hours practicing with their instruments to help develop precise, repeatable notes. One factor that has a direct impact on brass instrument consistency is the musician's lack of air pockets and misdirection of air through the mouthpiece. Additionally, the facial muscles which are utilized during the playing of the instruments need to be loose and capable of controlling airflow through the mouthpiece. Regardless of the type of brass instrument, each relies on the installation of a mouthpiece that is slid into one end of the instruments defined as the mouthpiece receiver or lead pipe. Once the mouthpiece is coupled to the instrument, the instrument is ready to be played. Each individual mouthpiece has a specified outer cup diameter, internal cup diameter, internal cup depth and overall mouthpiece length. The degree of variation of these parameters within a certain instrument is somewhat limited. While there is some variation in the cup characteristics, the shank portion that is slid into the instrument mouthpiece receiver or lead pipe is shaped to fit one type of instrument (i.e., trumpet, trombone, French horn, etc, . . . ). Not having any significant size variation of the cups limits the muscle development and overall range of the musician's tonal registry. Tonal registry is defined as the range of an instrument or voice. In this case we can attribute a portion of the tonal registry to the instruments mouthpiece as the size and shape dictate the instruments tone based on the rate of airflow and direction caused by the cup. Presently there is no fit-for-purpose method to work significantly higher or lower tonal registries without forcing the user to adapt their natural technique.

The present invention helps to satisfy all of these problems by providing the ability to adapt various cup sizes to a constant shank. The usage of both larger and smaller cup sizes (relative to the standard mouthpiece), enables the user to work different muscle groups and practice controlling the airflow through the mouthpiece. The shank portion of the invention is shaped with the identical taper found on standard mouthpieces. This shank portion is then slid into the open void in the end of the instrument defined as the mouthpiece receiver or lead pipe until the shank outer diameter comes in contact with the instrument tubing internal diameter which creates an interference fit. The exposed end of the shank will have either a male threaded member protruding from the end or a magnetic coupling. The cup portion is then mated to the shank with either an opposing female thread or polarly-opposed magnet. The joining of the shank and cup, completes the invention assembly. Whether the user wishes to practice the instrument with a larger or smaller diameter cup, the cup portion is simply replaced and the shank-cup mating is used to hold the components in-place.

Currently, the only way for a musician to satisfy the need to practice their instrument with significantly different cup sizes was to retrofit a mouthpiece from a different instrument. The problem is that each instrument has a different shank size (diameter and length) which causes the adaptation to leave a loose and non-airtight seal at the interface between the mouthpiece and the instrument. This results in insufficient user feedback and therefore lessens the effect of training with the adapted mouthpiece.

Accordingly, there is a need for an interchangeable mouthpiece for brass instruments that will enable the user to practice both higher and lower tonal registries while ensuring a sufficient shank-instrument interface. Second, the invention provides scalability for increasing or decreasing relative cup size. The present invention satisfies all of these needs and provides further related advantages.

### SUMMARY OF THE INVENTION

The interchangeable brass mouthpiece provides adaptability for the musician to install both larger and smaller cups while maintaining the instruments specific shank.

The interchangeable mouthpiece for brass instruments is installed onto a specified brass instrument by mating the shank portion to the instruments mouthpiece receiver or lead pipe. The user then can assemble the desired cup depending on what area of their tonal registry they wish to practice.

The overall design of the invention can be applied to any brass instrument. Only the shank portion will change to match the instrument-specific mouthpiece receiver or lead pipe.

Other features and advantages of the present invention will become apparent from the following more detailed description, when taken into conjunction with the accompanying drawings, which illustrate, by way of example, the principles of the invention.

### BRIEF DESCRIPTION OF THE DRAWINGS

FIG. 1 shows an assembled side view cutaway of an exemplary embodiment of the invention;

FIG. 2 shows a side view cutaway image illustrating the interchangeable cup portions of the exemplary embodiment of the invention from FIG. 1.

FIG. 3 shows an exploded isometric view of an exemplary embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a method for changing out the size of the mouthpiece cup to account for the desired tone register utilizing a single shank base. There are currently no products that offer the flexibility of the varied cup and “rim sizes” with a single base shank. Rationale: this product is again unique because it will offer radically different cup and rim sizes in a single unit set for the development of tonal ranges.

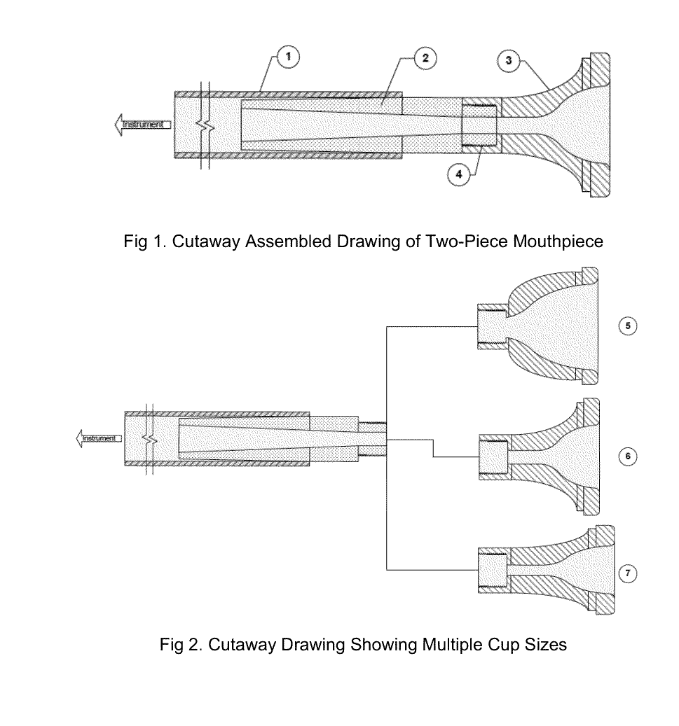

FIG. 1 shows an assembled side view cutaway of an exemplary embodiment of the invention. The invention may include a shank (2), a cup (3), a threaded connection (4) that is fitted into the brass instrument receiver tubing (1). The main structure of the device may be constructed of a rigid plastic, composite or metal and be designed with a slight taper to the shank to allow for the frictional binding with the inner receiver bore surface.

FIG. 2 shows a side view cutaway image illustrating the interchangeable cup portions of the exemplary embodiment of the invention from FIG. 1. The shank which is designed to be fitted into a specific brass instrument will be shown here as the consistent base for the set of interchangeable cups. The user has the option to exchange the cup size for one of higher or lower tone depending on the particular desire. The largest cup (5), the medium size cup (6) and the smallest size cup (7) is shown to illustrate the adaptability of the invention to receive various size cups.

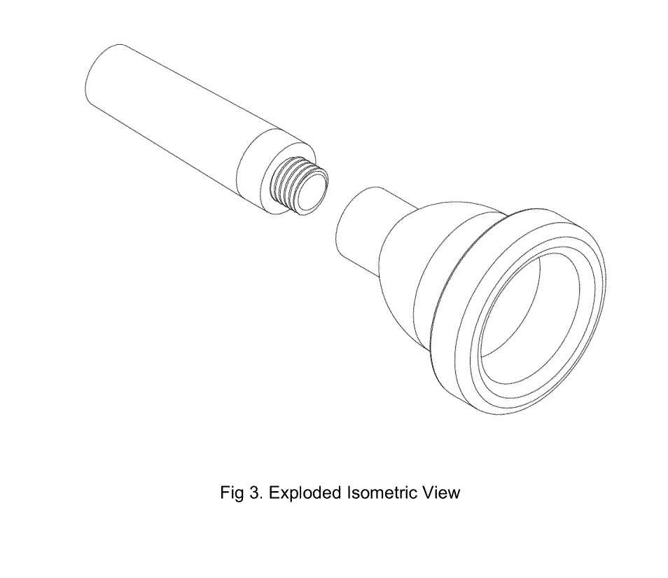

FIG. 3 shows an exploded isometric view of an exemplary embodiment of the invention.

In an exemplary embodiment, the device may be used with brass wind instruments such as; trumpet, trombone, French horn, tuba, sousaphone, cornet, flugelhorn, baritone, euphonium, etc.

In an exemplary embodiment, the device may be used in training of the facial muscles in preparation of wide ranging tonal registries.

It should be understood, of course, that the foregoing relates to exemplary embodiments of the invention and that modifications may be made without departing from the spirit and scope of the invention as set forth in the following claim.

1. An interchangeable mouthpiece assembly for brass wind instruments comprising:
a tapered shank with an internal bore; and
a cup with an internal cavity.

2. An interchangeable mouthpiece assembly for brass wind instruments as described in claim 1 in which the two components are joined together by a male-female integral thread.

3. An interchangeable mouthpiece assembly for brass wind instruments as described in claim 1 in which the two components are joined together by integral polar-attracted magnets.

4. An interchangeable mouthpiece assembly for brass wind instruments as described in claim 1 in which the two components are joined together by in interference fit tapered profile that joins to two pieces.

5. An interchangeable mouthpiece assembly for brass wind instruments as described in claim 1 in which the components are made of a metal or alloy.

6. An interchangeable mouthpiece assembly for brass wind instruments as described in claim 1 in which the components are made of plastic.

7. An interchangeable mouthpiece assembly for brass wind instruments as described in claim 1 in which the cup portion has varying dimensions to match or simulate high and low tonal registries.
